(19) United States
(12) Patent Application Publication
(10) Pub. No.: US 2026/0168956 A1
(43) Pub. Date: Jun. 18, 2026

(54) GAS SENSOR

(71) Applicant: NGK INSULATORS, LTD., Nagoya-shi (JP)

(72) Inventors: Ryo HASHIKAWA, Gifu-shi (JP); Taku OKAMOTO, Nagoya-shi (JP)

(21) Appl. No.: 19/402,512

(22) Filed: Nov. 26, 2025

(30) Foreign Application Priority Data
Dec. 18, 2024 (JP) 2024-223637

(51) Int. Cl. G01N 27/407; G01N 27/419

(52) U.S. Cl. CPC G01N 27/4074; G01N 27/419

(57) ABSTRACT

A gas sensor includes a sensor element and a control unit. The sensor element includes: a base part including a first solid electrolyte having proton conductivity, and a second solid electrolyte having a lower resistance value of proton conduction than the first solid electrolyte; a measurement-object gas flow cavity having an internal cavity; a current measurement pump cell including: an intracavity measurement electrode disposed on the second solid electrolyte in the internal cavity; a reference gas chamber; and a voltage detection sensor cell including: a reference electrode disposed on the first solid electrolyte in the reference gas chamber, and a detection electrode. The control unit includes: a pump control part, and a concentration calculating part that calculates the hydrogen concentration in the measurement-object gas based on an electromotive force generated in the voltage detection sensor cell; and/or based on a current flowing through the current measurement pump cell.

### CROSS-REFERENCE TO RELATED APPLICATION

The present application claims priority from Japanese Patent Application No. 2024-223637, filed on Dec. 18, 2024, the content of which is hereby incorporated by reference into this application.

### BACKGROUND OF THE INVENTION

### Technical Field of the Invention

The present invention relates to a gas sensor for detecting a hydrogen gas in a measurement-object gas, the gas sensor including a sensor element using a proton-conductive solid electrolyte.

### Background Art

As an example of a gas sensor that detects a hydrogen gas in a measurement-object gas, a gas sensor using a proton conductive solid electrolyte (a proton conductor) is known (for example, JP 2022-189215 A and JP S62-269054 A).

For example, JP 2022-189215 A discloses a hydrogen sensor having a reference electrode provided on a surface of a proton conductive solid electrolyte, and a measurement electrode provided on a surface of the proton conductive solid electrolyte in a second space different from a first space that the reference electrode faces. JP 2022-189215 A also discloses that in the hydrogen sensor, a hydrogen concentration in the second space is detected based on an electromotive force between the reference electrode and the measurement electrode. JP 2022-189215 A discloses a so-called voltage-type hydrogen sensor.

For example, JP S62-269054 A discloses a hydrogen sensor element in which an anode electrode and a cathode electrode are respectively provided on both surfaces of a hydrogen ion conductive solid electrolyte, and a hydrogen diffusion control body covering the anode electrode is provided. JP S62-269054 A also discloses that a hydrogen concentration is detected based on a limiting current characteristic of a current flowing between the anode electrode and the cathode electrode. JP S62-269054 A discloses a so-called limiting current-type hydrogen sensor.

### CITATION LIST

### Patent Documents

Patent Document 1: JP 2022-189215 A

Patent Document 2: JP S62-269054 A

### SUMMARY OF THE INVENTION

Problems to be solved by the Invention

A hydrogen gas sensor is used for detection or measurement of concentration of hydrogen in various fields where hydrogen is used. The hydrogen gas sensor can be used in, for example, a fuel cell, a hydrogen vehicle, an iron work and a petrochemical plant which treat hydrogen, hydrogen power generation, hydrogen production, hydrogen transportation, and the like. A concentration range to be measured may be different according to the usage of the hydrogen gas sensor. For example, when the hydrogen gas sensor is used for detection of hydrogen leakage in an industrial gas, the measurement range may differ widely depending on a concentration of a hydrogen gas to be used. It is considered that a hydrogen concentration in a measurement-object gas may vary, for example, from a low concentration such as about 100 ppm to a high concentration such as about 10% to 50% or more. In order to be adaptable to the various usage, the hydrogen gas sensor is required to be possible to accurately measure a hydrogen concentration in a wide concentration range.

It is therefore an object of the present invention to provide a gas sensor that can measure a concentration of a hydrogen gas in a measurement-object gas in a wide concentration range with high accuracy.

### Means for Solving the Problems

As a result of intensive studies, the present inventors reach the present invention. The present invention includes the following aspects.
(1) A gas sensor for detecting a hydrogen gas in a measurement-object gas, the gas sensor comprising a sensor element and a control unit for controlling the sensor element, wherein
the sensor element comprises:
   a base part including a first solid electrolyte having proton conductivity, and a second solid electrolyte arranged at least partly in contact with the first solid electrolyte and having a lower resistance value of proton conduction than the first solid electrolyte;
   a measurement-object gas flow cavity having a gas inlet that opens on a surface of the base part; and an internal cavity that communicates with the gas inlet via a diffusion-rate limiting path, on an inner surface of the internal cavity at least the second solid electrolyte being present;
   a current measurement pump cell including: an intracavity measurement electrode disposed on the second solid electrolyte in the internal cavity of the measurement-object gas flow cavity; and an extracavity measurement electrode disposed at a position different from the measurement-object gas flow cavity on the base part, and adjacent to the intracavity measurement electrode via the second solid electrolyte;
   a reference gas chamber formed inside the base part, and being separated from the measurement-object gas flow cavity, on an inner surface of the reference gas chamber at least the first solid electrolyte being present; and
   a voltage detection sensor cell including: a reference electrode disposed on the first solid electrolyte in the reference gas chamber; and a detection electrode disposed at a position different from each of the reference gas chamber and the measurement-object gas flow cavity on the base part, and adjacent to the reference electrode via the first solid electrolyte or via the first solid electrolyte and the second solid electrolyte, and
the control unit comprises:
   a pump control part for controlling the current measurement pump cell; and
   a concentration calculating part for calculating a hydrogen concentration in a measurement-object gas, wherein
the concentration calculating part calculates the hydrogen concentration in the measurement-object gas based on an electromotive force generated in the voltage detection sensor cell; and/or calculates the hydrogen concentration in the measurement-object gas based on a current flowing through the current measurement pump cell.

Generally, the concentration calculating part calculates the hydrogen concentration in the measurement-object gas based on an electromotive force generated in the voltage detection sensor cell when the hydrogen concentration in the measurement-object gas is a relatively low concentration; and
the concentration calculating part calculates the hydrogen concentration in the measurement-object gas based on a current flowing through the current measurement pump cell when the hydrogen concentration in the measurement-object gas is a relatively high concentration higher than the low concentration.
(2) The gas sensor according to the above (1), wherein
the concentration calculating part calculates the hydrogen concentration in the measurement-object gas based on the electromotive force generated in the voltage detection sensor cell when a value of the electromotive force generated in the voltage detection sensor cell is equal to or smaller than a predetermined threshold value; and
the concentration calculating part calculates the hydrogen concentration in the measurement-object gas based on the current flowing through the current measurement pump cell when the value of the electromotive force generated in the voltage detection sensor cell is larger than the predetermined threshold value.
(3) The gas sensor according to the above (1), wherein
the concentration calculating part calculates the hydrogen concentration in the measurement-object gas based on the electromotive force generated in the voltage detection sensor cell when a value of the current flowing through the current measurement pump cell is equal to or smaller than a predetermined threshold value; and
the concentration calculating part calculates the hydrogen concentration in the measurement-object gas based on the current flowing through the current measurement pump cell when the value of the current flowing through the current measurement pump cell is larger than the predetermined threshold value.
(4) The gas sensor according to the above (1), wherein
the concentration calculating part considers a hydrogen concentration calculated based on the electromotive force generated in the voltage detection sensor cell as the hydrogen concentration in the measurement-object gas when the hydrogen concentration calculated based on the electromotive force generated in the voltage detection sensor cell is equal to or smaller than a predetermined threshold value; and
the concentration calculating part calculates the hydrogen concentration in the measurement-object gas based on the current flowing through the current measurement pump cell when the hydrogen concentration calculated based on the electromotive force generated in the voltage detection sensor cell is larger than the predetermined threshold value.
(5) The gas sensor according to the above (1), wherein
the concentration calculating part calculates the hydrogen concentration in the measurement-object gas based on the electromotive force generated in the voltage detection sensor cell when a hydrogen concentration calculated based on the current flowing through the current measurement pump cell is equal to or smaller than a predetermined threshold value; and
the concentration calculating part considers the hydrogen concentration calculated based on the current flowing through the current measurement pump cell as the hydrogen concentration in the measurement-object gas when the hydrogen concentration calculated based on the current flowing through the current measurement pump cell is larger than the predetermined threshold value.
(6) The gas sensor according to any one of the above (1) to (5), wherein the pump control part applies a predetermined voltage between the intracavity measurement electrode and the extracavity measurement electrode of the current measurement pump cell to make a current flow through the current measurement pump cell.
(7) The gas sensor according to any one of the above (1) to (6), wherein
the first solid electrolyte is a proton conductor selected from the group consisting of Ca—Zr—Mn—O based and Ca—Zr—In—O based perovskite compounds, and
the second solid electrolyte is a proton conductor selected from the group consisting of Sr—Zr—Y—O based, Ba—Zr—Y—O based, Ba—Ce—Y—O based and Sr—Zr—Yb—O based perovskite compounds.
(8) A sensor element for detecting a hydrogen gas in a measurement-object gas, the sensor element comprising:
a base part including a first solid electrolyte having proton conductivity, and a second solid electrolyte arranged at least partly in contact with the first solid electrolyte and having a lower resistance value of proton conduction than the first solid electrolyte;
a measurement-object gas flow cavity having a gas inlet that opens on a surface of the base part; and an internal cavity that communicates with the gas inlet via a diffusion-rate limiting path, on an inner surface of the internal cavity at least the second solid electrolyte being present;
a current measurement pump cell including: an intracavity measurement electrode disposed on the second solid electrolyte in the internal cavity of the measurement-object gas flow cavity; and an extracavity measurement electrode disposed at a position different from the measurement-object gas flow cavity on the base part, and adjacent to the intracavity measurement electrode via the second solid electrolyte;
a reference gas chamber formed inside the base part, and being separated from the measurement-object gas flow cavity, on an inner surface of the reference gas chamber at least the first solid electrolyte being present; and
a voltage detection sensor cell including: a reference electrode disposed on the first solid electrolyte in the reference gas chamber; and a detection electrode disposed at a position different from each of the reference gas chamber and the measurement-object gas flow cavity on the base part, and adjacent to the reference electrode via the first solid electrolyte or via the first solid electrolyte and the second solid electrolyte.

### Advantageous Effect of the Invention

According to the present invention, it is possible to provide a gas sensor that can measure a concentration of a hydrogen gas in a measurement-object gas in a wide concentration range with high accuracy.

### BRIEF DESCRIPTION OF THE DRAWINGS

FIG. 1 is a vertical sectional schematic view in a longitudinal direction of a sensor element 101, showing one example of a schematic configuration of a gas sensor 100 of Embodiment 1.

FIG. 2 is a block diagram showing electric connections between a control unit 90 and respective pump cells 21 and 31 of the sensor element 101.

FIG. 3 is a schematic diagram showing an example of a relationship between a H₂ concentration in a measurement-object gas and a pump current Ip1 in the gas sensor 100. The horizontal axis represents the H₂ gas concentration (%), and the vertical axis represents the pump current Ip1 (A).

FIG. 4 is a schematic diagram showing an example of a relationship between the H₂ concentration in the measurement-object gas and a voltage V2 in the gas sensor 100. FIG. 4 is a semilogarithmic graph in which the horizontal axis is a logarithmic scale and the vertical axis is a linear scale. The horizontal axis represents the H₂ gas concentration (%), and the vertical axis represents the voltage V2 (V).

FIG. 5 is a schematic diagram showing an example of a relationship between the H₂ concentration in the measurement-object gas and the voltage V2 in the gas sensor 100. FIG. 5 is a graph plotted on a linear scale for each of the horizontal axis and the vertical axis. The horizontal axis represents the H₂ gas concentration (%), and the vertical axis represents the voltage V2 (V).

FIG. 6 is a schematic diagram showing the relationship between the H₂ concentration in the measurement-object gas and the pump current Ip1 (FIG. 3), and the relationship between the H₂ concentration in the measurement-object gas and the voltage V2 (FIG. 5) in the gas sensor 100 on the same graph. FIG. 6 is a graph plotted on a linear scale for each of the horizontal axis and the vertical axis. The horizontal axis represents the H₂ gas concentration (%), and the vertical axis represents the pump current Ip1 (A) or the voltage V2 (V).

FIG. 7 is a vertical sectional schematic view in a longitudinal direction of a sensor element 201, showing one example of a schematic configuration of a gas sensor 200 of Embodiment 2.

### MODES FOR CARRYING OUT OF THE INVENTION

A gas sensor of the present invention includes a sensor element and a control unit for controlling the sensor element.

The sensor element contained in the gas sensor of the present invention includes:
a base part including a first solid electrolyte having proton conductivity, and a second solid electrolyte arranged at least partly in contact with the first solid electrolyte and having a lower resistance value of proton conduction than the first solid electrolyte;
a measurement-object gas flow cavity having a gas inlet that opens on a surface of the base part; and an internal cavity that communicates with the gas inlet via a diffusion-rate limiting path, on an inner surface of the internal cavity at least the second solid electrolyte being present;
a current measurement pump cell including: an intracavity measurement electrode disposed on the second solid electrolyte in the internal cavity of the measurement-object gas flow cavity; and an extracavity measurement electrode disposed at a position different from the measurement-object gas flow cavity on the base part, and adjacent to the intracavity measurement electrode via the second solid electrolyte;
a reference gas chamber formed inside the base part, and being separated from the measurement-object gas flow cavity, on an inner surface of the reference gas chamber at least the first solid electrolyte being present; and
a voltage detection sensor cell including: a reference electrode disposed on the first solid electrolyte in the reference gas chamber; and a detection electrode disposed at a position different from each of the reference gas chamber and the measurement-object gas flow cavity on the base part, and adjacent to the reference electrode via the first solid electrolyte or via the first solid electrolyte and the second solid electrolyte.

The control unit contained in the gas sensor of the present invention includes:
a pump control part for controlling the current measurement pump cell; and
a concentration calculating part for calculating a hydrogen concentration in a measurement-object gas, wherein
the concentration calculating part calculates the hydrogen concentration in the measurement-object gas based on an electromotive force generated in the voltage detection sensor cell; and/or calculates the hydrogen concentration in the measurement-object gas based on a current flowing through the current measurement pump cell.

Generally, the concentration calculating part calculates the hydrogen concentration in the measurement-object gas based on the electromotive force generated in the voltage detection sensor cell when the hydrogen concentration in the measurement-object gas is a relatively low concentration; and
the concentration calculating part calculates the hydrogen concentration in the measurement-object gas based on the current flowing through the current measurement pump cell when the hydrogen concentration in the measurement-object gas is a relatively high concentration higher than the low concentration.

### Embodiment 1

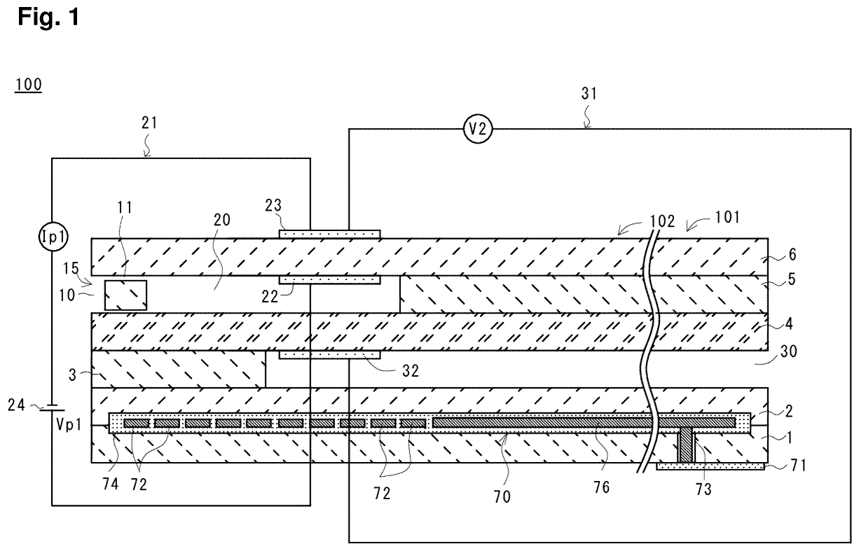

One example of embodiments of the gas sensor according to the present invention will now be described with reference to the drawings. FIG. 1 is a vertical sectional schematic view in a longitudinal direction, showing one example of a schematic configuration of a gas sensor 100 including a sensor element 101. Hereinafter, based on FIG. 1, the upper side and the lower side in FIG. 1 are respectively defined as top and bottom, and the left side and the right side in FIG. 1 are respectively defined as a front end side and a rear end side.

In FIG. 1, the gas sensor 100 represents one example of a gas sensor that detects hydrogen H₂ in a measurement-object gas by the sensor element 101, and measures the concentration of H₂.

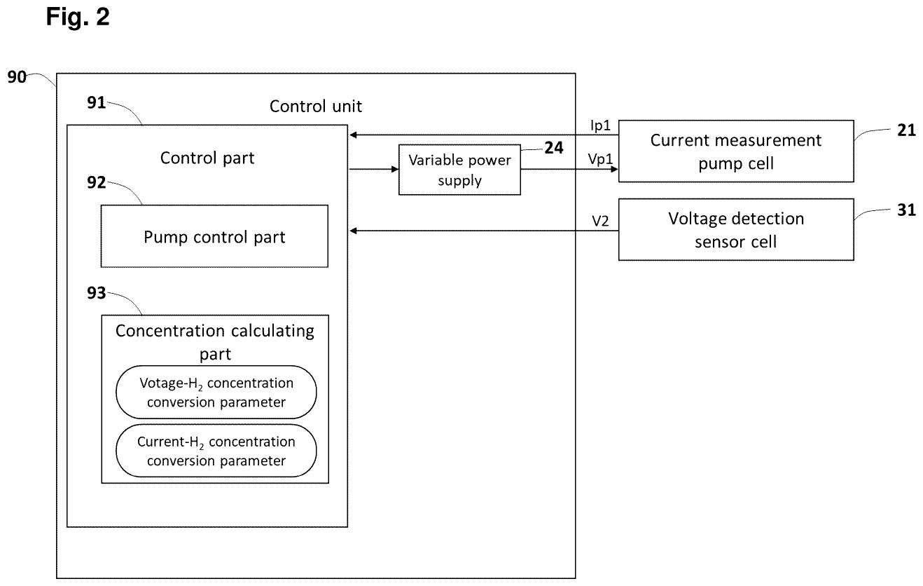

Further, the gas sensor 100 includes a control unit 90 for controlling the sensor element 101. FIG. 2 is a block diagram showing electric connections between the control unit 90 and the sensor element 101.

### (Sensor Element)

The sensor element 101 is an element having a base part 102 including a first solid electrolyte body having proton conductivity, and a second solid electrolyte body arranged at least partly in contact with the first solid electrolyte body and having a lower resistance value of proton conduction than the first solid electrolyte body. In this embodiment, the sensor element 101 is an element in an elongated plate shape. The elongated plate shape also called a long plate shape or a belt shape. The base part 102 includes two kind of proton-conductive solid electrolyte bodies each having different proton conductivity (namely, having a different resistance value).

As a solid electrolyte having proton conductivity (also referred to as a proton-conductive solid electrolyte, or a proton conductor), for example, a perovskite type oxide and the like may be used. Specific explanation regarding the proton conductor will be described later.

The base part 102 has such a structure that six layers, namely, a first substrate layer 1, a second substrate layer 2, a first spacer layer 3, a first proton conductor layer 4, a second spacer layer 5, and a second proton conductor layer 6, are layered in substantially parallel in this order from the bottom side, as viewed in the drawing. Each of the six layers is formed of a proton-conductive solid electrolyte layer. The solid electrolyte forming these six layers is dense and gastight. These six layers all may have the same thickness, or the thickness may vary among the layers. The layers are adhered to each other with an adhesive layer of a solid electrolyte interposed therebetween, and the base part 102 includes the adhesive layer. While a layer configuration composed of the six layers is illustrated in FIG. 1, the layer configuration in the present invention is not limited to this, and any number of layers and any layer configuration are possible. Further, a part of the layers (for example, the first substrate layer 1, the second substrate layer 2, and the first spacer layer 3) may be composed of, for example, a dense layer formed of an insulator such as alumina.

In this embodiment, the first proton conductor layer 4 is a layer composed of a first solid electrolyte (also referred to as a first solid electrolyte layer). Each of the first substrate layer 1, the second substrate layer 2, the first spacer layer 3, the second spacer layer 5, and the second proton conductor layer 6 is a layer composed of a second solid electrolyte (also referred to as a second solid electrolyte layer) that has a lower resistance value of proton conduction than the first solid electrolyte.

A measurement-object gas flow cavity 15 has a gas inlet 10 that opens on a surface of the base part 102, and an internal cavity 20 that communicates with the gas inlet 10 via a diffusion-rate limiting path 11 (namely, a diffusion-rate limiting part), on an inner surface of the internal cavity 20 at least the second solid electrolyte being present. In this embodiment, the internal cavity 20 is a space defined by the second spacer layer 5 and the second proton conductor layer 6 composed of the second solid electrolyte, and the first proton conductor layer 4 composed of the first solid electrolyte.

In this embodiment, the gas inlet 10 is formed between the lower surface of the second proton conductor layer 6 and the upper surface of the first proton conductor layer 4 in one end part in a longitudinal direction (hereinafter, referred to as a front end part) of the sensor element 101. The measurement-object gas flow cavity 15, that is, a measurement-object gas flow part is formed in such a form that the diffusion-rate limiting path 11 and the internal cavity 20 communicate in this order in the longitudinal direction from the gas inlet 10.

The gas inlet 10 and the internal cavity 20 constitute internal spaces of the sensor element 101. Each of the internal spaces is provided in such a manner that a portion of the second spacer layer 5 is hollowed out, and the top of each of the internal spaces is defined by the lower surface of the second proton conductor layer 6 composed of the second solid electrolyte, the bottom of each of the internal spaces is defined by the upper surface of the first proton conductor layer 4 composed of the first solid electrolyte, and the lateral surface of each of the internal spaces is defined by the lateral surface of the second spacer layer 5 composed of the second solid electrolyte. That is, each of the gas inlet 10 and the internal cavity 20 faces the second spacer layer 5 and the second proton conductor layer 6 composed of the second solid electrolyte, and the first proton conductor layer 4 composed of the first solid electrolyte.

The diffusion-rate limiting path 11 is provided as two laterally elongated slits (having the longitudinal direction of the openings in the direction perpendicular to the figure in FIG. 1). The diffusion-rate limiting path 11 may be in such a form that a desired diffusion resistance is created, but the form is not limited to the slits.

A reference gas chamber 30 is formed inside the base part 102 separated from the measurement-object gas flow cavity 15, and on an inner surface of the reference gas chamber 30 at least the first solid electrolyte (namely, the first proton conductor layer 4) is present. In this embodiment, at a position farther from the front end than the diffusion-rate limiting path 11 of the measurement-object gas flow part 15, the reference gas chamber 30 is disposed between the upper surface of the second substrate layer 2 and the lower surface of the first proton conductor layer 4 at a position where the reference gas chamber 30 is laterally defined by the lateral surface of the first spacer layer 3. The reference gas chamber 30 has an opening in the other end part (hereinafter, referred to as a rear end part) of the sensor element 101. The reference gas chamber 30 is a space extends in the longitudinal direction from the opening in the rear end part of the sensor element 101 to a position where the internal cavity 20 exists (for example, near the middle of the internal cavity 20 in the longitudinal direction). As a reference gas for concentration measurement, for example, air is introduced into the reference gas chamber 30.

In the measurement-object gas flow cavity 15, the gas inlet 10 is open to the external space, and the measurement-object gas is taken into the sensor element 101 from the external space through the gas inlet 10.

In the present embodiment, the measurement-object gas flow cavity 15 is in such a form that the measurement-object gas is introduced through the gas inlet 10 that is open on the front end surface of the sensor element 101, however, the present invention is not limited to this form. For example, the measurement-object gas flow cavity 15 need not have a recess of the gas inlet 10. In this case, the diffusion-rate limiting path 11 substantially serves as a gas inlet.

For example, the measurement-object gas flow cavity 15 may have an opening that communicates with a position near the front end part of the internal cavity 20, for example, at a position closer to the front end part than an inner measurement electrode 22 that will be described later, on a lateral surface along the longitudinal direction of the base part 102. In this case, the measurement-object gas is introduced from the lateral surface along the longitudinal direction of the base part 102 through the opening.

Further, for example, the measurement-object gas flow cavity 15 may be so configured that the measurement-object gas is introduced through a porous body.

The diffusion-rate limiting path 11 creates a predetermined diffusion resistance to the measurement-object gas taken through the gas inlet 10.

The internal cavity 20 is provided as a space for measuring a current corresponding to a hydrogen concentration in the measurement-object gas introduced through the diffusion-rate limiting path 11. This measurement is done by the operation of a current measurement pump cell 21.

The current measurement pump cell 21 is an electrochemical pump cell including an intra-cavity measurement electrode (in this embodiment, an inner measurement electrode 22) disposed on the second solid electrolyte (in this embodiment, the second proton conductor layer 6) in the internal cavity 20 of the measurement-object gas flow cavity 15; and an extra-cavity measurement electrode (in this embodiment, an outer electrode 23) disposed at a position different from the measurement-object gas flow cavity 15 on the base part 102, and adjacent to the inner measurement electrode 22 via the second proton conductor layer 6.

That is, the current measurement pump cell 21 is an electrochemical pump cell composed of the inner measurement electrode 22 disposed on the lower surface of the second proton conductor layer 6 that faces the internal cavity 20, the outer electrode 23 disposed on a region of the upper surface of the second proton conductor layer 6 that corresponds to the inner measurement electrode 22 so as to be exposed to the external space, and the second proton conductor layer 6 sandwiched between the inner measurement electrode 22 and the outer electrode 23.

The inner measurement electrode 22 and the outer electrode 23 may be porous cermet electrodes (electrodes in a state that a metal component and a ceramic component are mixed). The ceramic component to be used is not particularly limited, but is preferably a solid electrolyte having proton conductivity as in the case of the second proton conductor layer 6 with which the inner measurement electrode 22 and the outer electrode 23 are both in contact. For example, the second solid electrolyte as will be described later in detail can be used as the ceramic component.

The inner measurement electrode 22 preferably contains a noble metal having catalytic activity (e.g., at least one of Pt, Rh, Ir, Ru, and Pd) as the metal component. For example, the inner measurement electrode 22 may be a porous cermet electrode made of Pt and the second solid electrolyte. The outer electrode 23 preferably contains a noble metal having catalytic activity (e.g., at least one of Pt, Rh, Ir, Ru, Pd and Au) as the metal component. For example, the outer electrode 23 may be a porous cermet electrode made of Au and Pt, and the second solid electrolyte.

In the current measurement pump cell 21, a desired pump voltage Vp1 is applied between the inner measurement electrode 22 and the outer electrode 23 by a variable power supply 24 to make a pump current Ip1 flow between the inner measurement electrode 22 and the outer electrode 23, and thus it is possible to pump out hydrogen in the internal cavity 20 to the external space.

A reference electrode 32 disposed on the first solid electrolyte (in this embodiment, the first proton conductor layer 4) in the reference gas chamber 30; and a detection electrode disposed at a position different from each of the reference gas chamber 30 and the measurement-object gas flow cavity 15, and adjacent to the reference electrode 32 via the first solid electrolyte or via the first solid electrolyte and the second solid electrolyte form an electrochemical sensor cell, namely, a voltage detection sensor cell 31. The reference electrode 32 is disposed to be in contact with a reference gas, and the detection electrode is disposed to be in contact with a measurement-object gas. In this embodiment, the outer electrode 23 functions also as the detection electrode of the present invention. The outer electrode 23 is disposed adjacent to the reference electrode 32 via the first solid electrolyte (namely, the first proton conductor layer 4) and the second solid electrolyte (namely, the second spacer layer 5 and the second proton conductor layer 6).

That is, the voltage detection sensor cell 31 is an electrochemical sensor cell consisting of the reference electrode 32, the outer electrode 23, the first proton conductor layer 4 composed of the first solid electrolyte, and the second spacer layer 5 and the second proton conductor layer 6 composed of the second solid electrolyte.

The reference electrode 32 is an electrode disposed on the first solid electrolyte, namely, on the lower surface of the first proton conductor layer 4, in the reference gas chamber 30. The reference electrode 32 is disposed to be in contact with a reference gas via the reference gas chamber 30.

The reference electrode 32 may be a porous cermet electrode (an electrode in a state that a metal component and a ceramic component are mixed) as in the case of the inner measurement electrode 22 and the outer electrode 23. The ceramic component to be used is not particularly limited, but is preferably a solid electrolyte having proton conductivity as in the case of the first proton conductor layer 4 with which the reference electrode 32 is in contact. For example, the first solid electrolyte as will be described later in detail can be used as the ceramic component.

The reference electrode 32 preferably contains a noble metal having catalytic activity (e.g., at least one of Pt, Rh, Ir, Ru, and Pd) as the metal component. For example, the reference electrode 32 may be a porous cermet electrode made of Pt and the first solid electrolyte.

In the voltage detection sensor cell 31, an electromotive force (a voltage V2) is generated between the reference electrode 32 and the outer electrode 23 due to a difference in concentration between a hydrogen concentration in the measurement-object gas in contact with the outer electrode 23 and a hydrogen concentration in the reference gas in the reference gas chamber 30. As described above, the outer electrode 23 may be a porous cermet electrode made of Au and Pt, and the second solid electrolyte. When Au is used as the metal component, it is considered that since combustion of hydrogen in the measurement-object gas at the outer electrode 23 as the detection electrode can be suppressed, the electromotive force (the voltage V2) that more precisely corresponds to the hydrogen concentration in the measurement-object gas can be detected in the voltage detection sensor cell 31.

The sensor element 101 further includes a heater part 70 that functions as a temperature regulator of heating and maintaining the temperature of the sensor element 101 so as to enhance the hydrogen ion conductivity (or, the proton conductivity) of the solid electrolytes. The heater part 70 includes a heater electrode 71, a heater 72, a through hole 73, a heater lead 76, and a heater insulating layer 74.

The heater electrode 71 is an electrode formed in contact with the lower surface of the first substrate layer 1. The power can be supplied to the heater part 70 from the outside by connecting the heater electrode 71 with an external power supply.

The heater 72 is an electrical resistor sandwiched by the first substrate layer 1 and the second substrate layer 2 from top and bottom. The heater 72 is connected with the heater electrode 71 via the heater lead 76 that connects with the heater 72 and extends in the rear end side in the longitudinal direction of the sensor element 101, and the through hole 73. The heater 72 is externally powered through the heater electrode 71 to generate heat, and heats and maintains the temperature of the solid electrolyte forming the sensor element 101.

The heater 72 is embedded over the whole area over the internal cavity 20 so that the temperature of the sensor element 101 can be adjusted to such a temperature that activates the proton-conductive solid electrolyte. The temperature may be adjusted so that the current measurement pump cell 21 is operable. It is not necessary that the whole area is adjusted to the same temperature, but the sensor element 101 may have temperature distribution. By maintaining the heater 72 at a desired temperature, the sensor element 101 can be maintained at a driving temperature at which the solid electrolyte is activated and thus H₂ concentration is accurately measured.

Hydrogen gas has an ignition temperature of 500° C. to 571° C. (refer to Information Support System concerning Dangerous Substance Disaster, at Fire and Disaster Management Agency, Ministry of Internal Affairs and Communications). Therefore, a driving temperature of the gas sensor 100 is required to be lower than 500° C. at highest. On the other hand, the driving temperature of the gas sensor 100 is required to be such a temperature that the solid electrolyte develops proton conductivity. The driving temperature of the gas sensor 100 may appropriately be determined depending on the configuration of the sensor element 101such as materials of the first solid electrolyte and the second solid electrolyte, and the intended use and use environment of the gas sensor 100, and may be, for example, about 300° C. or more and 45 0 ° C. or less.

In the sensor element 101 of the present embodiment, the heater 72 is embedded in the base part 102, but this form is not limitative. The heater 72 may be disposed to heat the base part 102. That is, the heater 72 may heat the sensor element 101 to develop proton conductivity with which the current measurement pump cell 21 is operable. For example, the heater 72 may be embedded in the base part 102 as in the present embodiment. Alternatively, for example, the heater part 70 may be formed as a heater substrate that is separate from the base part 102, and may be disposed at a position adjacent to the base part 102.

The heater insulating layer 74 is formed of an insulator such as alumina on the upper and lower surfaces of the heater 72 and the heater lead 76. The heater insulating layer 74 is formed to ensure electrical insulation between the first substrate layer 1, and the heater 72 and the heater lead 76, and electrical insulation between the second substrate layer 2, and the heater 72 and the heater lead 76.

### (Control Unit)

The gas sensor 100 of this embodiment includes the sensor element 101 described above and the control unit 90 for controlling the sensor element 101. In the gas sensor 100, each of the electrodes 22, 23, and 32 of the sensor element 101 is electrically connected to the control unit 90 through a lead wire not shown. FIG. 2 is a block diagram showing electric connections between the control unit 90 and the respective cells 21 and 31 of the sensor element 101. The control unit 90 includes the above-described variable power supply 24 and a control part 91. The control part 91 includes a pump control part 92 and a concentration calculating part 93.

The control part 91 is realized by a general-purpose or dedicated computer, and functions as the pump control part 92 and the concentration calculating part 93 are realized by a CPU, a memory or the like installed in the computer. It is to be noted that when the gas sensor 100 is used as a part of various measurement devices, some or all of the functions of the control unit 90 (especially, the control unit 91) may be realized by a CPU, a memory or the like installed in the measurement device.

The control part 91 is configured to acquire a pump current Ip1 in the current measurement pump cell 21 and an electromotive force (a voltage V2) in the voltage detection sensor cell 31 of the sensor element 101. Further, the control part 91 is configured to output a control signal to the variable power supply 24.

The pump control part 92 is configured to control the operation of the current measurement pump cell 21 so as to measure a concentration of a hydrogen gas in a measurement-object gas.

In this embodiment, the pump control part 92 applies a predetermined pump voltage Vp1 between the intracavity measurement electrode (namely, the inner measurement electrode 22) and the extracavity measurement electrode (namely, the outer electrode 23) of the current measurement pump cell 21 to make a current (pump current Ip1) flow through the current measurement pump cell 21.

When a pump voltage Vp1 is applied between the inner measurement electrode 22 and the outer electrode 23 of the current measurement pump cell 21 so that hydrogen is pumped out from the internal cavity 20 to the external space, a pump current Ip1 increases as the pump voltage Vp1 is increased while the pump voltage Vp1 is low. Subsequently, when the pump voltage Vp1 becomes high, the pump current Ip1 does not increase even when the pump voltage Vp1 is increased, and becomes to be saturated. A value of the saturated current at this time is referred to as a limiting current value. A region in which the pump current Ip1 is at the limiting current value with respect to the pump voltage Vp1 is referred to as a limiting current region. In the limiting current region, it is considered that substantially all of hydrogen that reaches the inner measurement electrode 22 is pumped out by the current measurement pump cell 21.

In driving the gas sensor 100, the pump control part 92 applies the predetermined pump voltage Vp1 between the intracavity measurement electrode (the inner measurement electrode 22) and the extracavity measurement electrode (the outer electrode 23) in the current measurement pump cell 21 by the variable power supply 24 to pump out hydrogen in the measurement-object gas from the internal cavity 20. In this case, the pump current Ip1 flowing through the current measurement pump cell 21 flows from the outer electrode 23 toward the inner measurement electrode 22 in the outside of the sensor element 101.

The pump voltage Vp1 applied to the current measurement pump cell 21 may be set as a value such that all of, or substantially all of hydrogen in the measurement-object gas introduced into the internal cavity 20 is pumped out. The pump voltage Vp1 may be set to a value such that the pump current Ip1 is at the above limiting current. The pump voltage Vp1 may vary depending on the intended use of the gas sensor 100, the configuration of the sensor element 101 and the like, and the pump voltage Vp1 may be, for example, about 100 mV or more and about 1000 mV or less.

It is to be noted that the pump control part 92 does not perform control such as applying a voltage to the voltage detection sensor cell 31 as in the case of the current measurement pump cell 21, because in the voltage detection sensor cell 31, the electromotive force (the voltage V2) is generated due to the existence of the concentration difference between the hydrogen concentration in the measurement-object gas in contact with the outer electrode 23 and the hydrogen concentration in the reference gas in the reference gas chamber 30.

The concentration calculating part 93 is configured to calculate a hydrogen concentration (H₂ concentration) in a measurement-object gas. The concentration calculating part 93 calculates the hydrogen concentration in the measurement-object gas based on the electromotive force (the voltage V2) in the voltage detection sensor cell 31; and/or calculates the hydrogen concentration in the measurement-object gas based on the current (the pump current Ip1) flowing through the current measurement pump cell 21.

The concentration calculating part 93 is configured to acquire the voltage V2 in the voltage detection sensor cell 31, to calculate H₂ concentration in a measurement-object gas on the basis of a previously-stored conversion parameter (voltage-H₂ concentration conversion parameter) between the voltage V2 and the H₂ concentration in the measurement-object gas, and to output the H₂ concentration as a measurement value of the gas sensor 100. The voltage-H₂ concentration conversion parameter is previously stored in the memory of the control part 91 which functions as the concentration calculating part 93. The voltage-H₂ concentration conversion parameter may appropriately be determined by those skilled in the art by, for example, previously performing an experiment on the gas sensor 100. The voltage-H₂ concentration conversion parameter may be, for example, the coefficient of an approximate expression (e.g., logarithmic function) obtained by experiment or a map showing the relationship between the voltage V2 and the H₂ concentration in the measurement-object gas. The voltage-H₂ concentration conversion parameter may be specific to each individual gas sensor 100 or may be common to a plurality of gas sensors.

The concentration calculating part 93 is configured to acquire the pump current Ip1 in the current measurement pump cell 21, to calculate H₂ concentration in a measurement-object gas on the basis of a previously-stored conversion parameter (current-H₂ concentration conversion parameter) between the pump current Ip1 and the H₂ concentration in the measurement-object gas, and to output the H₂ concentration as a measurement value of the gas sensor 100. The current-H₂ concentration conversion parameter is previously stored in the memory of the control part 91 which functions as the concentration calculating part 93. The current-H₂ concentration conversion parameter may appropriately be determined by those skilled in the art by, for example, previously performing an experiment on the gas sensor 100. The current-H₂ concentration conversion parameter may be, for example, the coefficient of an approximate expression (e.g., linear function) obtained by experiment or a map showing the relationship between the pump current Ip1 and the H₂ concentration in the measurement-object gas. The current-H₂ concentration conversion parameter may be specific to each individual gas sensor 100 or may be common to a plurality of gas sensors.

Generally, the concentration calculating part 93 calculates the hydrogen concentration in the measurement-object gas based on the electromotive force (voltage V2) generated in the voltage detection sensor cell 31 when the hydrogen concentration in the measurement-object gas is a relatively low concentration; and
the concentration calculating part 93 calculates the hydrogen concentration in the measurement-object gas based on the current (pump current Ip1) flowing through the current measurement pump cell 21 when the hydrogen concentration in the measurement-object gas is a relatively high concentration higher than the low concentration.

The concentration calculating part 93 may always perform both of the calculation of the hydrogen concentration based on the voltage V2 and the calculation of the hydrogen concentration based on the pump current Ip1. Alternatively, the concentration calculating part 93 may select and perform ether the calculation of the hydrogen concentration based on the voltage V2 or the calculation of the hydrogen concentration based on the pump current Ip1, on the basis of the hydrogen concentration in the measurement-object gas or the like. The concentration calculating part 93 may output one of the hydrogen concentration calculated based on the voltage V2 and the hydrogen concentration calculated based on the pump current Ip1 as a measurement value of the gas sensor 100.

### (Current Measurement Pump Cell and Voltage Detection Sensor Cell)

The current measurement pump cell 21 and the voltage detection sensor cell 31 will be described in detail.

The pump control part 92 operates the current measurement pump cell 21 to pump out all of, or substantially all of hydrogen in a measurement-object gas introduced into the internal cavity 20. A pump current Ip1 flowing through the current measurement pump cell 21 at this time is to be a value corresponding to the hydrogen concentration in the measurement-object gas.

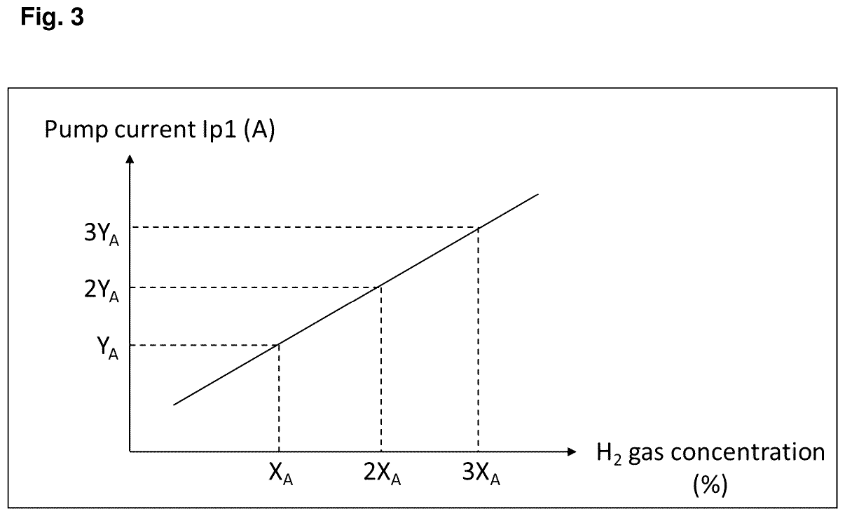

FIG. 3 is a schematic diagram showing an example of a relationship between the H₂ concentration (the H₂ gas concentration) in the measurement-object gas and the pump current Ip1 in the gas sensor 100. The horizontal axis represents the H₂ gas concentration (%), and the vertical axis represents the pump current Ip1 (A). In the current measurement pump cell 21, the pump current Ip1 is applied to pump out substantially all of hydrogen in the measurement-object gas introduced into the internal cavity 20. Therefore, as shown in FIG. 3, a linear relationship exists between the H₂ concentration in the measurement-object gas and the pump current Ip1. The gas sensor 100 can measure the H₂ concentration on the basis of such a linear relationship between the H₂ concentration and the pump current Ip1.

In order to obtain such a linear relationship more precisely, it is preferred that a resistance value in the current measurement pump cell 21 is low and hydrogen is smoothly pumped out. Therefore, it is preferred that the second solid electrolyte (namely, the second proton conductor layer 6) interposed between the intracavity measurement electrode (namely, the inner measurement electrode 22) and the extracavity measurement electrode (namely, the outer electrode 23) has high proton conductivity, that is, a low resistance value for proton conduction.

Generally, the resistance value of the solid electrolyte decreases as the temperature increases. However, as described above, hydrogen gas has the ignition temperature of 500° C. to 571° C., and a driving temperature of the gas sensor 100 is therefore required to be lower than 500° C. at highest. Thus, the second solid electrolyte (namely, the second proton conductor layer 6) may preferably have a low resistance value at lower than 500° C., for example, at a low temperature equal to or lower than about 450° C.

When the H₂ concentration is calculated based on the pump current Ip1, measurement accuracy tends to be higher as the H₂ concentration is higher. As shown in FIG. 3, as the H₂ concentration increases, a current value of the pump current Ip1 becomes larger so that a signal-to-noise ratio (S/N ratio) becomes higher, and thus higher sensitivity can be obtained. As a result, it is considered to be possible to obtain high measurement accuracy. When the H₂ concentration is an extremely low concentration, the pump current Ip1 becomes quite small, and it is therefore considered that accuracy decreases compared to the case of the high concentration.

As described above, in the voltage detection sensor cell 31, the electromotive force (the voltage V2) is generated between the reference electrode 32 and the outer electrode 23 due to the difference in concentration between the hydrogen concentration in the measurement-object gas in contact with the outer electrode 23 and the hydrogen concentration in the reference gas in the reference gas chamber 30.

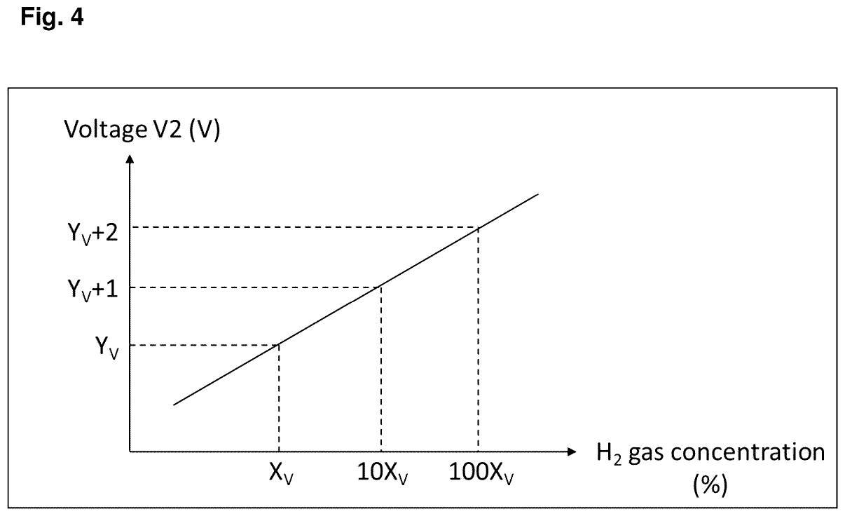

FIG. 4 is a schematic diagram showing an example of a relationship between the H₂ concentration in the measurement-object gas and the voltage V2 in the gas sensor 100. FIG. 4 is a semilogarithmic graph in which the horizontal axis is a logarithmic scale and the vertical axis is a linear scale. The horizontal axis represents the H₂ gas concentration (%), and the vertical axis represents the voltage V2 (V). The voltage V2 in the voltage detection sensor cell 31 is an electromotive force generated due to the difference in concentration between the hydrogen concentration in the measurement-object gas and the hydrogen concentration in the reference gas. A relationship between the hydrogen concentration and the electromotive force (the voltage V2) follows the so-called Nernst's equation, and therefore a linear relationship exists between the logarithm of the H₂ concentration and the voltage V2. The gas sensor 100 can measure the H₂ concentration on the basis of such a relationship between the H₂ concentration and the voltage V2.

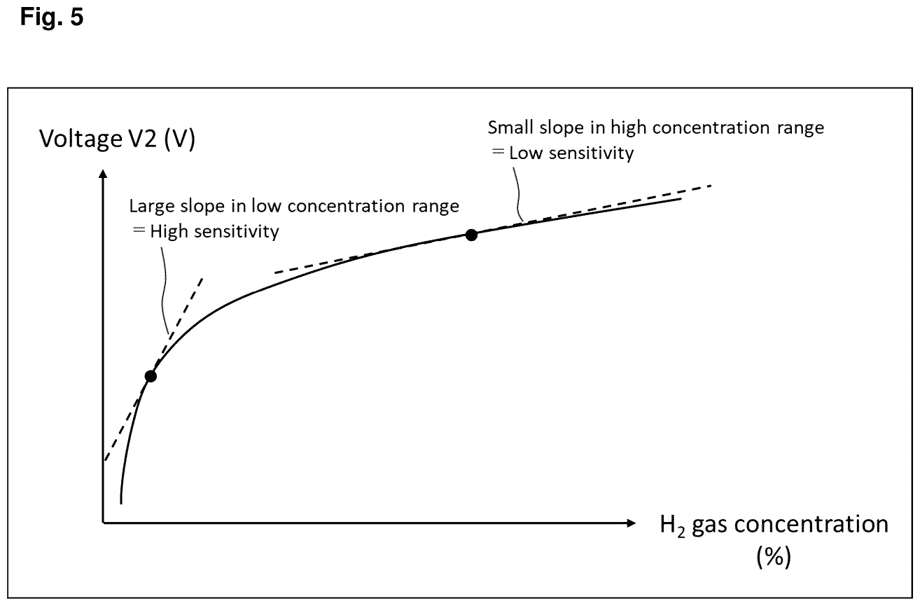

FIG. 5 is a schematic diagram showing an example of a relationship between the H₂ concentration in the measurement-object gas and the voltage V2 in the gas sensor 100. FIG. 5 is a graph plotted on a linear scale for each of the horizontal axis and the vertical axis. That is, FIG. 5 is the schematic diagram when the scale of the horizontal axis is changed from the logarithmic scale in FIG. 4 to the linear scale. The horizontal axis represents the H₂ gas concentration (%), and the vertical axis represents the voltage V2 (V). As shown in FIG. 5, a slope of the graph is larger as the H₂ concentration is lower, and the slope of the graph is smaller as the H₂ concentration is higher. In other words, change in the voltage V2 with respect to concentration change is larger as the H₂ concentration is lower, and the change in the voltage V2 with respect to the concentration change is smaller as the H₂ concentration is higher.

Therefore, when the H₂ concentration is calculated based on the voltage V2, measurement accuracy tends to be higher as the H₂ concentration is lower. As the H₂ concentration decreases, the change in the voltage V2 with respect to the concentration change becomes larger, and thus higher sensitivity to the H₂ concentration can be obtained. As a result, it is considered to be possible to obtain high measurement accuracy.

As described above, the voltage V2 is an electric potential difference between the reference electrode 32 and the outer electrode 23. Thus, when an electric potential of the reference electrode 32 that serves as a reference for measurement is kept constant, the voltage V2 is to be a value corresponding to an electric potential of the outer electrode 23, that is, the hydrogen concentration in the measurement-object gas. Keeping the electric potential of the reference electrode 32 constant generally means keeping the hydrogen concentration in the reference gas in contact with the reference electrode 32 constant. In order to supply a gas with a predetermined hydrogen concentration to the sensor element 101, for example, a gas cylinder filled with a gas with the predetermined hydrogen concentration can be used. However, in this case, the gas sensor may become large, and this may restrict the applications because of, for example, limitation of mounting space for the gas sensor, and may be unpreferable. Therefore, the air may preferably be used as the reference gas.

Hydrogen exists in a very small amount in the air. It is concerned that minute variation of hydrogen concentration may cause a deviation of the electric potential of the reference electrode 32. Especially when the reference electrode 32 is in contact with a solid electrolyte having high proton conductivity, it is considered that the deviation of the electric potential is likely to occur. Therefore, the first solid electrolyte (namely, the first proton conductor layer 4) in contact with the reference electrode 32 may preferably be a solid electrolyte having low proton conductivity, that is, having a high resistance value for proton conduction in a range of very low hydrogen concentration such as the hydrogen concentration in the air. Alternatively, the first solid electrolyte may be a solid electrolyte having substantially no proton conductivity in the range of the very low hydrogen concentration such as the hydrogen concentration in the air. In this case, it is not particularly limited whether the proton conductivity in a range of higher hydrogen concentration than the hydrogen concentration in the air (for example, hydrogen concentration in the measurement-object gas) is high or low.

In the present invention, a resistance value of a proton conductor used for the second solid electrolyte is lower than a resistance value of a proton conductor used for the first solid electrolyte. As described above, the first solid electrolyte may preferably be a solid electrolyte having a high resistance value of proton conduction, that is, having low proton conductivity in the range of very low hydrogen concentration such as the hydrogen concentration in the air. Further, the second solid electrolyte may preferably be a solid electrolyte having a low resistance value of proton conduction, that is, having high proton conductivity.

As an index of the resistance value of proton conduction of the first solid electrolyte and the second solid electrolyte, for example, a value of a so-called direct-current resistance, a value of a real part of impedance obtained by measurement of alternating-current impedance, or the like may be used.

The direct-current resistance may be measured in, for example, the following manner. First, the sensor element 101 having the second proton conductor layer 6 composed of a solid electrolyte for which a resistance value is to be measured is manufactured as a sensor element to be measured. The sensor element to be measured is heated up to a driving temperature by the heater 72. In this state, in the air atmosphere, a predetermined voltage Vp1 is applied between the inner measurement electrode 22 and the outer electrode 23, and a pump current Ip1 flowing at the time is measured. A value (a direct-current resistance value) obtained by dividing the applied voltage Vp1 by the measured pump current Ip1 may be defined as the resistance value.

Impedance is a ratio of a voltage to a current in an alternating current circuit, and is generally expressed by a complex number. The impedance is also called as complex impedance. In the complex impedance, a real part represents a resistance component of the impedance, and an imaginary part represents a reactance component of the impedance. The impedance is measured by measurement of alternating-current impedance.

Specifically, a resistance value may be measured in the following manner. First, the sensor element 101 having the second proton conductor layer 6 composed of a solid electrolyte for which a resistance value is to be measured is manufactured as a sensor element to be measured. The sensor element to be measured is heated up to a driving temperature by the heater 72. In this state, in the air atmosphere, the measurement of the alternating-current impedance is performed. The measurement of the alternating-current impedance may be performed in an inert gas atmosphere, in a gas atmosphere with oxygen concentration of, for example, 20.5% simulating the air, or in an atmosphere simulating an objective gas component in a measurement-object gas such as an exhaust gas of an automobile. The measurement of the alternating-current impedance can be performed using a known measurement apparatus such as an impedance analyzer. An alternating-current voltage is applied between the inner measurement electrode 22 and the outer electrode 23 while a frequency of the voltage is varied to obtain a frequency characteristic of impedance. A real part of impedance at a predetermined frequency may be defined as the resistance value of the solid electrolyte. An alternating-current voltage of a predetermined frequency may be applied to measure impedance at the predetermined frequency, and a real part of the impedance may be defined as the resistance value.

The resistance value of the first solid electrolyte may be, for example, 1 kΩ or more as the direct-current resistance value in the air. When the resistance value is within such a range, it is considered that the electric potential can be maintained constant. Alternatively, the resistance value may be 5 kΩ or more, or 10 kΩ or more. The first solid electrolyte may be a proton-conductive solid electrolyte layer. An upper limit of the resistance value is not particularly limited, and may be, for example, about 50 kΩ or less.

The resistance value of the second solid electrolyte may be, for example, 500Ω or less as the direct-current resistance value in the air. When the resistance value is within such a range, it is considered that hydrogen can be pumped out smoothly in the current measurement pump cell 21. Alternatively, the resistance value may be 200Ω or less, or 100Ω or less. A lower limit of the resistance value is not particularly limited, and may be, for example, about 20Ω or more.

Further, as an index indicating proton conductivity of the first solid electrolyte and the second solid electrolyte, for example, proton conductivity may be used. The proton conductivity indicates the ease of proton conduction, in contrast to the resistance. High proton conductivity indicates a low resistance, and low proton conductivity indicates a high resistance. Therefore, in the present invention, the proton conductivity of the proton conductor used as the second solid electrolyte is higher than the proton conductivity of the proton conductor used as the first solid electrolyte. The proton conductivity can be measured by a known method.

As the proton-conductive solid electrolyte (the proton conductor) used for the first solid electrolyte (in this embodiment, the first proton conductor layer 4) and the second solid electrolyte (in this embodiment, the second spacer layer 5 and the second proton conductor layer 6), for example, a perovskite type ceramic represented by the following composition formula may be used.

A(B₁₋ₓCₓ)O_{3-δ}

Here, “A” is, for example, a bivalent metal selected from the group consisting of Ba, Ca, and Sr. “B” is, for example, a tetravalent metal selected from the group consisting of Ce and Zr. “C” is, for example, a trivalent metal selected from the group consisting of In, Y, Yb, Mn, and Sc. “C” is a so-called dopant. “x” may be 0 or more and 0.7 or less.

Specifically, each of the first solid electrolyte and the second solid electrolyte may be selected from, for example, the group consisting of perovskite compounds of Sr(Zr₁₋ₓ Yₓ)O_{3-δ}(Sr—Zr—Y—O based, or SZY), Ba(Zr₁₋ₓYₓ)O_{3-δ}(Ba—Zr—Y—O based), Ba(Ce₁₋ₓYₓ)O_{3-δ}(Ba—Ce—Y—O based), Sr(Zr₁₋ₓYbₓ)O_{3-δ}(Sr—Zr—Yb—O based), Ca(Zr₁₋ₓMnₓ)O_{3-δ}(Ca—Zr—Mn—O based, or CZMN), and Ca(Zr₁₋ₓInₓ)O_{3-δ}(Ca—Zr—In—O based). It is premised that the second solid electrolyte has a lower resistance value of proton conduction, that is, higher proton conductivity than the first solid electrolyte.

As the first solid electrolyte, for example, a proton conductor selected from, for example, the group consisting of perovskite compounds of Ca(Zr₁₋ₓMnₓ)O_{3-δ}(Ca—Zr—Mn—O based, or CZMN), and Ca(Zr₁₋ₓInₓ)O_{3-δ}(Ca—Zr—In—O based) may be used. Here, “x” may be 0 or more and 0.7 or less. More specifically, for example, Ca(Zr_{0.95}Mn_{0.05})O_{3-δ}may be used. As the second solid electrolyte, a proton conductor selected from, for example, the group consisting of perovskite compounds of Sr(Zr₁₋ₓYₓ)O_{3-δ}(Sr—Zr—Y—O based, or SZY), Ba(Zr₁₋ₓYₓ)O_{3-δ}(Ba—Zr—Y—O based), Ba(Ce₁₋ₓYₓ)O_{3-δ}(Ba—Ce—Y—O based), and Sr(Zr₁₋ₓYbₓ)O_{3-δ}(Sr—Zr—Yb—O based) may be used. Here, “x” may be 0 or more and 0.7 or less. More specifically, for example, Sr(Zr_{0.8}Y_{0.2})O_{3-δ}to Sr(Zr_{0.95}Y_{0.05})O_{3-δ}may be used.

Also, a perovskite compound other than the above, or a non-perovskite type compound may appropriately be selected in terms of the proton conductivity and the resistance value.

### Measurement of Hydrogen Concentration in the Measurement-Object Gas

Next, a method for measuring concentration of hydrogen H₂ in the measurement-object gas by using the gas sensor 100 having such a configuration as described above will be described.

The measurement-object gas is introduced from the gas inlet 10, passes through the diffusion-rate limiting path 11 so that a predetermined diffusion resistance is imparted to the measurement-object gas, and reaches the internal cavity 20.

When the pump control part 92 operates the current measurement pump cell 21 as described above, all or substantially all of hydrogen in the measurement-object gas introduced into the internal cavity 20 is pumped out. The pump current Ip1 flowing through the current measurement pump cell 21 is to be at a current value corresponding to an amount of hydrogen in the measurement-object gas reaching the internal cavity 20. Here, the relationship between the H₂ concentration in the measurement-object gas and the pump current Ip1 is such a linear relationship as shown in FIG. 3.

As described above, in the voltage detection sensor cell 31, the electromotive force (the voltage V2) is generated between the reference electrode 32 and the outer electrode 23 due to the difference in concentration between the hydrogen concentration in the measurement-object gas in contact with the outer electrode 23 and the hydrogen concentration in the reference gas in the reference gas chamber 30. Here, the relationship between the H₂ concentration in the measurement-object gas and the voltage V2 is such a relationship as shown in FIG. 5.

As described above, generally, the concentration calculating part 93 calculates the hydrogen concentration in the measurement-object gas based on an electromotive force (voltage V2) generated in the voltage detection sensor cell 31 when the hydrogen concentration in the measurement-object gas is a relatively low concentration; and
the concentration calculating part 93 calculates the hydrogen concentration in the measurement-object gas based on the current (pump current Ip1) flowing through the current measurement pump cell 21 when the hydrogen concentration in the measurement-object gas is a relatively high concentration higher than the low concentration.

When the H₂ concentration in the measurement-object gas is the relatively low concentration, as described above, the change in the voltage V2 with respect to the concentration change becomes large, and thus high sensitivity to the H₂ concentration can be obtained. Therefore, higher measurement accuracy can be obtained by calculating the H₂ concentration based on the voltage V2 (hereinafter, also referred to as voltage measurement). On the other hand, when the H₂ concentration in the measurement-object gas is the relatively high concentration, as described above, the current value of the pump current Ip1 becomes large, and thus high sensitivity can be obtained. Therefore, higher measurement accuracy can be obtained by calculating the H₂ concentration based on the pump current Ip1 (hereinafter, also referred to as current measurement).

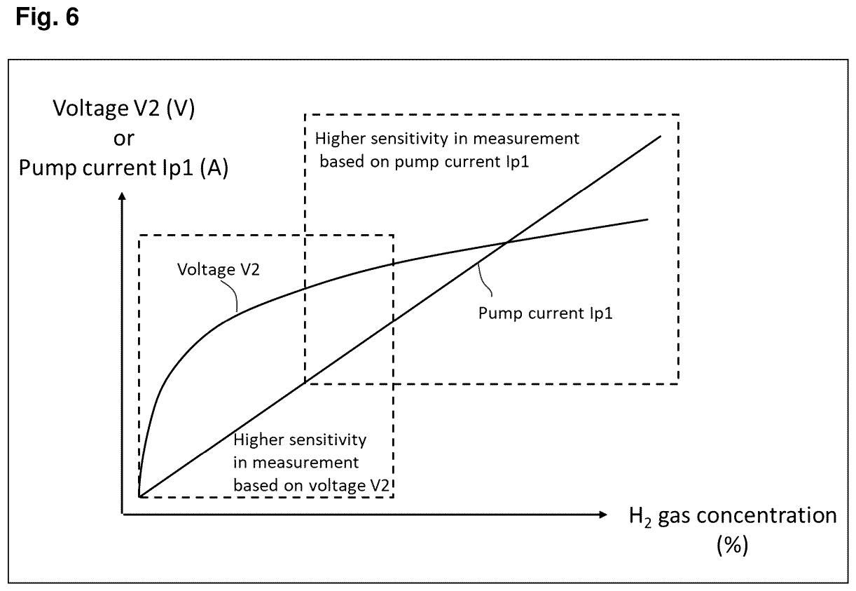

FIG. 6 is a schematic diagram showing the relationship between the H₂ concentration in the measurement-object gas and the pump current Ip1 (FIG. 3), and the relationship between the H₂ concentration in the measurement-object gas and the voltage V2 (FIG. 5) in the gas sensor 100 on the same graph. FIG. 6 is a graph plotted on a linear scale for each of the horizontal axis and the vertical axis. It is to be noted that FIG. 6 merely shows each of the pump current Ip1 and the voltage V2 schematically, and does not indicate the magnitude of actual values. The horizontal axis represents the H₂ gas concentration (%), and the vertical axis represents the pump current Ip1 (A) or the voltage V2 (V). In FIG. 6, each of a concentration range of higher sensitivity in the measurement based on the voltage V2, and a concentration range of higher sensitivity in the measurement based on the pump current Ip1 is shown with a broken line.

A measurement range of the voltage measurement may be a range of relatively low concentration. The range of relatively low concentration may be the concentration range of higher sensitivity in the measurement based on the voltage V2 in FIG. 6. The measurement range of the voltage measurement may be, for example, about 10% or less of the hydrogen concentration. When the measurement range is within such a range, the change in the voltage V2 with respect to the concentration change does not become too small, and it is therefore considered to be possible to maintain high measurement accuracy. A lower limit of the measurement range of the voltage measurement is not particularly limited, and may be, for example, about 100 ppm or more of the hydrogen concentration.

A measurement range of the current measurement may be a range of relatively high concentration. The range of relatively high concentration may be the concentration range of higher sensitivity in the measurement based on the pump current Ip1 in FIG. 6. The measurement range of the current measurement may be, for example, about 1% or more of the hydrogen concentration. When the measurement range is within such a range, the current value of the pump current Ip1 does not become too small, and it is therefore considered to be possible to maintain high measurement accuracy. An upper limit of the measurement range of the current measurement is not particularly limited, and may be, for example, about 50% or less of the hydrogen concentration.

The concentration calculating part 93 may calculate the hydrogen concentration in the measurement-object gas based on the electromotive force (the voltage V2) generated in the voltage detection sensor cel1 31 (namely, perform the voltage measurement) when the hydrogen concentration in the measurement-object gas is equal to or smaller than a predetermined concentration threshold value (alternatively, smaller than a predetermined concentration threshold value); and
the concentration calculating part 93 may calculate the hydrogen concentration in the measurement-object gas based on the current (the pump current Ip1) flowing through the current measurement pump cell 21 (namely, perform the current measurement) when the hydrogen concentration in the measurement-object gas is larger than the predetermined concentration threshold value (alternatively, equal to or larger than the predetermined concentration threshold value).

The concentration threshold value may appropriately be selected so that the gas sensor 100 can maintain high measurement accuracy in a wide concentration range. As shown in FIG. 6, the concentration range of higher sensitivity in the voltage measurement and the concentration range of higher sensitivity in the current measurement partially overlap. In the concentration range of the overlapping portion, it is considered that sufficiently high measurement accuracy can be achieved regardless of whether the voltage measurement or the current measurement is adopted. Therefore, as the concentration threshold value, a hydrogen concentration within the concentration range of the overlapping portion may appropriately be selected.

The concentration threshold value may be, for example, about 1% or more and about 10% or less. For example, the concentration threshold value may be about 1% or more, about 3% or more, or about 5% or more, and may be about 10% or less, about 8% or less, or about 6% or less.

The concentration calculating part 93 may determine that the hydrogen concentration in the measurement-object gas is a low concentration and calculate the hydrogen concentration in the measurement-object gas based on the electromotive force (the voltage V2) generated in the voltage detection sensor cell 31, when a value of the electromotive force (the voltage V2) generated in the voltage detection sensor cell 31 is equal to or smaller than a predetermined threshold value (referred to a voltage threshold value) (alternatively, smaller than the predetermined voltage threshold value); and
the concentration calculating part 93 may determine that the hydrogen concentration in the measurement-object gas is a high concentration and calculate the hydrogen concentration in the measurement-object gas based on the current (the pump current Ip1) flowing through the current measurement pump cell 21, when the value of the electromotive force (the voltage V2) generated in the voltage detection sensor cell 31 is larger than the predetermined voltage threshold value (alternatively, equal to or larger than the predetermined voltage threshold value).

The voltage threshold value may appropriately be selected so that the gas sensor 100 can maintain high measurement accuracy in a wide concentration range. The voltage threshold value may be a voltage value corresponding to the above concentration threshold value. The voltage threshold value may be, for example, a voltage value corresponding to the hydrogen concentration of about 1% or more and about 10% or less.

The concentration calculating part 93 may determine that the hydrogen concentration in the measurement-object gas is a low concentration and calculate the hydrogen concentration in the measurement-object gas based on the electromotive force (the voltage V2) generated in the voltage detection sensor cell 31, when a value of the current (the pump current Ip1) flowing through the current measurement pump cell 21 is equal to or smaller than a predetermined threshold value (referred to a current threshold value) (alternatively, smaller than the predetermined current threshold value); and
the concentration calculating part 93 may determine that the hydrogen concentration in the measurement-object gas is a high concentration and calculate the hydrogen concentration in the measurement-object gas based on the current (the pump current Ip1) flowing through the current measurement pump cell 21, when the value of the current (the pump current Ip1) flowing through the current measurement pump cell 21 is larger than the predetermined current threshold value (alternatively, equal to or larger than the predetermined current threshold value).

The current threshold value may appropriately be selected so that the gas sensor 100 can maintain high measurement accuracy in a wide concentration range. The current threshold value may be a current value corresponding to the above concentration threshold value. The current threshold value may be, for example, a current value corresponding to the hydrogen concentration of about 1% or more and about 10% or less.

Alternatively, the concentration calculating part 93 may determine that the hydrogen concentration in the measurement-object gas is a low concentration and consider a hydrogen concentration calculated based on the electromotive force (the voltage V2) generated in the voltage detection sensor cell 31 as the hydrogen concentration in the measurement-object gas, when the hydrogen concentration calculated based on the electromotive force (the voltage V2) generated in the voltage detection sensor cell 31 is equal to or smaller than a predetermined concentration threshold value (alternatively, smaller than the predetermined concentration threshold value); and
the concentration calculating part 93 may determine that the hydrogen concentration in the measurement-object gas is a high concentration and calculate the hydrogen concentration in the measurement-object gas based on the current (the pump current Ip1) flowing through the current measurement pump cell 21, when the hydrogen concentration calculated based on the electromotive force (the voltage V2) generated in the voltage detection sensor cell 31 is larger than the predetermined concentration threshold value (alternatively, equal to or larger than the predetermined concentration threshold value).

Also, the concentration calculating part 93 may determine that the hydrogen concentration in the measurement-object gas is a low concentration and calculate the hydrogen concentration in the measurement-object gas based on the electromotive force (the voltage V2) generated in the voltage detection sensor cell 31, when a hydrogen concentration calculated based on the current (the pump current Ip1) flowing through the current measurement pump cell 21 is equal to or smaller than a predetermined concentration threshold value (alternatively, smaller than the predetermined concentration threshold value); and
the concentration calculating part 93 may determine that the hydrogen concentration in the measurement-object gas is a high concentration and consider the hydrogen concentration calculated based on the current (the pump current Ip1) flowing through the current measurement pump cell 21 as the hydrogen concentration in the measurement-object gas, when the hydrogen concentration calculated based on the current (the pump current Ip1) flowing through the current measurement pump cell 21 is larger than the predetermined concentration threshold value (alternatively, equal to or larger than the predetermined concentration threshold value).

The concentration threshold value may appropriately be selected so that the gas sensor 100 can maintain high measurement accuracy in a wide concentration range. The concentration threshold value may be, for example, about 1% or more and about 10% or less. For example, the concentration threshold value may be about 1% or more, about 3% or more, or about 5% or more, and may be about 10% or less, about 8% or less, or about 6% or less.

In driving the gas sensor 100, the concentration calculating part 93 may always perform both of the calculation of hydrogen concentration based on the electromotive force (the voltage V2) generated in the voltage detection sensor cell 31, and the calculation of hydrogen concentration based on the current (the pump current Ip1) flowing through the current measurement pump cell 21, or may perform either one. When either one of the calculations is performed, the concentration calculating part 93 may select the calculation based on the electromotive force (the voltage V2) or the calculation based on the current (the pump current Ip1), on the basis of any one of the electromotive force (the voltage V2) generated in the voltage detection sensor cell 31, the current (the pump current Ip1) flowing through the current measurement pump cell 21, the hydrogen concentration calculated based on the electromotive force (the voltage V2) generated in the voltage detection sensor cell 31, and the hydrogen concentration calculated based on the current (the pump current Ip1) flowing through the current measurement pump cell 21. The concentration calculating part 93 may perform measurement of hydrogen concentration while switching between the calculation based on the electromotive force (the voltage V2) and the calculation based on the current (the pump current Ip1).

### Embodiment 2

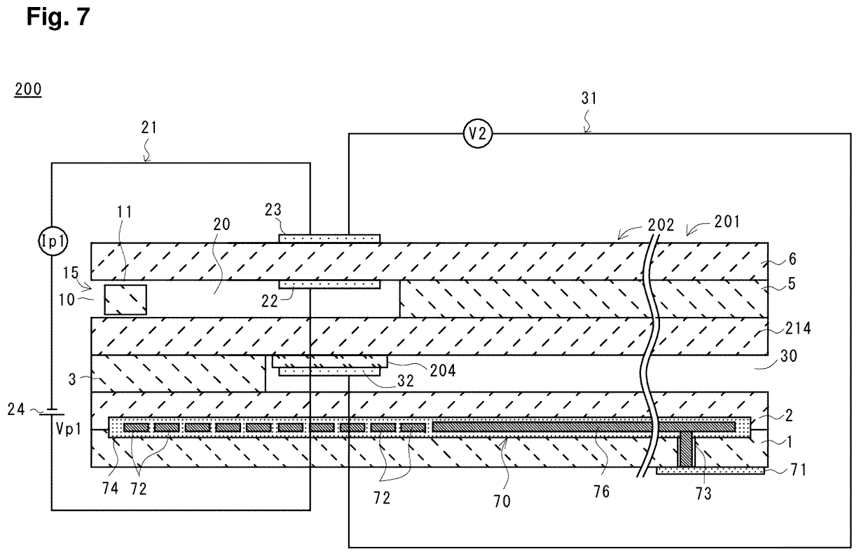

As another example of embodiments of the gas sensor according to the present invention, a gas sensor 200 of Embodiment 2 is shown. FIG. 7 is a vertical sectional schematic view in the longitudinal direction, showing one example of a schematic configuration of a gas sensor 200 including a sensor element 201. In FIG. 7, the same member as in FIG. 1 is denoted by the same sign.

A base part 202 has such a structure that six layers, namely, a first substrate layer 1, a second substrate layer 2, a first spacer layer 3, a lower proton conductor layer 214, a second spacer layer 5, and a second proton conductor layer 6, are layered in substantially parallel in this order from the bottom side, as viewed in the drawing. Each of the six layers is formed of a proton-conductive solid electrolyte layer. Each of the first substrate layer 1, the second substrate layer 2, the first spacer layer 3, the lower proton conductor layer 214, the second spacer layer 5, and the second proton conductor layer 6 is a layer composed of the second solid electrolyte.

In the sensor element 201, an internal cavity 20 is a space defined by the lower proton conductor layer 214, the second spacer layer 5, and the second proton conductor layer 6 that are composed of the second solid electrolyte.

In the sensor element 201, a first proton conductor layer 204 is arranged at a position facing the reference gas chamber 30 on a lower surface of the lower proton conductor layer 214. The first proton conductor layer 204 is a layer composed of the first solid electrolyte. The first proton conductor layer 204 may be arranged, in a longitudinal direction of the sensor element 201, at a position where the internal cavity 20 exists, for example, at a position around where the inner measurement electrode 22 exists. The reference electrode 32 is disposed on the first proton conductor layer 204 in the reference gas chamber 30.

In the sensor element 201, the voltage detection sensor cell 31 is an electrochemical sensor cell consisting of the reference electrode 32, the outer electrode 23, the first proton conductor layer 204 composed of the first solid electrolyte, and the lower proton conductor layer 214, the second spacer layer 5 and the second proton conductor layer 6 composed of the second solid electrolyte.

Hydrogen concentration in a measurement-object gas can be measured as described above also with the sensor element 201 by using the control unit 90, as in the case of the sensor element 101.

Embodiments 1 and 2 have been described above as examples of the embodiments according to the present invention, but the present invention is not limited thereto. The present invention may include a gas sensor having any structure including a sensor element and a control unit as long as the object of the present invention can be achieved, that is, a gas sensor that can measure a concentration of a hydrogen gas in a measurement-object gas in a wide concentration range with high accuracy is provided.

In the above-described Embodiments 1 and 2, the outer electrode 23 has two functions as an extracavity measurement electrode in the current measurement pump cell 21, and a detection electrode in the voltage detection sensor cell 31. However, the outer electrode 23 is not limited thereto. For example, the extracavity measurement electrode and the detection electrode may be formed as different electrodes.

In the above-described Embodiments 1 and 2, the outer electrode 23 as the extracavity measurement electrode in the current measurement pump cell 21 is disposed at a position of the upper surface of the second proton conductor layer 6 that corresponds to the inner measurement electrode 22 as the intracavity measurement electrode. However, the outer electrode 23 as the extracavity measurement electrode is not limited thereto. The outer electrode 23 may be disposed at a position different from the inner measurement electrode 22 in the longitudinal direction of the sensor element 101 (the base part 102). The outer electrode 23 may be disposed at a position different from the inner measurement electrode 22 in a width direction perpendicular to the longitudinal direction. The extracavity measurement electrode and the intracavity measurement electrode may be positioned with the second solid electrolyte being interposed therebetween. The extracavity measurement electrode is not required to be in contact with a measurement-object gas, and, for example, the extracavity measurement electrode may be positioned on the second solid electrolyte in the reference gas chamber 30 of Embodiment 2. When configuring the extracavity measurement electrode in the current measurement pump cell 21 to be disposed at a position not in contact with the measurement-object gas such as in the reference gas chamber 30, the detection electrode in the voltage detection sensor cell 31 may be formed at a position in contact with the measurement-object gas as a different electrode from the extracavity measurement electrode in the current measurement pump cell 21.

In the above-described Embodiments 1 and 2, the reference electrode 32 that constitutes the voltage detection sensor cell 31 is disposed on the first solid electrolyte, and the outer electrode 23 as the detection electrode is disposed on the second solid electrolyte. However, the present invention is not limited to this embodiment. The reference electrode 32 may be disposed on the first solid electrolyte. The detection electrode in the voltage detection sensor cell 31 may be in contact with a measurement-object gas, and may be disposed in contact with either the first solid electrolyte or the second solid electrolyte. When configuring the detection electrode to be disposed on the first solid electrolyte, the extracavity measurement electrode in the current measurement pump cell 21 may be formed on the second solid electrolyte as a different electrode from the detection electrode in the voltage detection sensor cell 31.

In the above-described Embodiments 1 and 2, the reference electrode 32 in the voltage detection sensor cell 31 is disposed on substantially the same position as the outer electrode 23 as the detection electrode in the longitudinal direction of the sensor element 101 (the base part 102). However, the reference electrode 32 is not limited thereto. The reference electrode 32 may be disposed at a position different from the outer electrode 23 in the longitudinal direction of the sensor element 101 (the base part 102). The reference electrode 32 may be disposed at a position different from the outer electrode 23 in a width direction perpendicular to the longitudinal direction. More preferably, the reference electrode 32 may be disposed on substantially the same position as the outer electrode 23 as the detection electrode in the longitudinal direction of the sensor element 101 (the base part 102). In this case, temperature difference between the reference electrode 32 and the outer electrode 23 becomes small to reduce influence of thermoelectromotive force generated by the temperature difference. Therefore, it is considered that the electromotive force (the voltage V2) corresponding to hydrogen concentration in a measurement-object gas can be measured with higher accuracy.

In the above-described gas sensor 100 of Embodiments 1, the pump control part 92 pumps out hydrogen in a measurement-object gas from the internal cavity 20 by applying a predetermined pump voltage Vp1 between the inner measurement electrode 22 and the outer electrode 23 of the current measurement pump cell 21 by the variable power supply 24 to make the pump current Ip1 flow through the current measurement pump cell 21. However, the present invention is not limited thereto. For example, the pump control part 92 may apply a predetermined pump voltage Vp1 between the inner measurement electrode 22 and the outer electrode 23 of the current measurement pump cell 21 based on an electromotive force generated between the reference electrode 32, and the inner measurement electrode 22 of the current measurement pump cell 21. The electromotive force generated between the reference electrode 32 and the inner measurement electrode 22 is to be a value corresponding to hydrogen concentration in the internal cavity 20. Therefore, the pump voltage Vp1 of the variable power supply 24 may be feedback controlled so that the electromotive force becomes constant. This is considered to enable that the pump current Ip1 flowing through the current measurement pump cell 21 is to be a value more accurately corresponding to the hydrogen concentration in the measurement-object gas.

In the above-described Embodiments 1 and 2, each of the sensor element 101 and the sensor element 201 is the element in the elongated plate shape. However, a shape of the sensor element is not limited thereto. The sensor element may be any structure having the measurement-object gas flow cavity and the reference gas chamber 30, and may be in various shapes, such as in a disc shape and in a cylinder shape.

### Method for Producing Gas Sensor

Next, one example of a method for producing the gas sensor as described above is described. A plurality of unfired sheet moldings (so-called green sheets) containing a proton-conductive solid electrolyte as a ceramic component are subjected to a predetermined processing and printing of circuit pattern, and then the plurality of sheets are laminated, and the laminate was cut, and then fired. Thus the sensor element 101 can be manufactured. Then, the manufactured sensor element may be incorporated into the gas sensor.

Hereinafter, description is made while taking the case of manufacturing the sensor element 101 composed of six layers shown in FIG. 1 as an example.

First, one green sheet containing a first solid electrolyte such as a Ca—Zr—Mn—O based perovskite compound as a ceramic component, and five green sheets containing a second solid electrolyte such as a Sr—Zr—Y—O based perovskite compound as a ceramic component are prepared. The one green sheet containing the first solid electrolyte as the ceramic component is used as the first proton conductor layer 4, and the five green sheets containing the second solid electrolyte as the ceramic component is used as other five layers. For manufacturing of the green sheets, a known molding method can be used. The six green sheets may all have the same thickness, or the thickness differs depending on the layer to be formed. In each of the six green sheets, sheet holes or the like for use in positioning at the time of printing or stacking are formed in advance by a known method such as a punching process with a punching apparatus to prepare a blank sheet. In the blank sheet for use as the second spacer layer 5, penetrating parts such as the internal cavity are also formed in the same manner. Also in the remaining layers, necessary penetrating parts are formed in advance.

The blank sheets for use as six layers, namely, the first substrate layer 1, the second substrate layer 2, the first spacer layer 3, the first proton conductor layer 4, the second spacer layer 5, and the second proton conductor layer 6 are subjected to printing of various patterns required for respective layers and drying treatment. For printing of a pattern, a known screen printing technique can be used. Also as the drying treatment, a known drying means can be used.

After completing the printing and drying of diverse patterns for each of the six blank sheets by repeating these steps, contact bonding treatment of stacking the six printed blank sheets in a predetermined order while positioning with the sheet holes and the like, and contact bonding at a predetermined temperature and pressure condition to give a laminate is conducted. The contact bonding treatment is conducted by heating and pressurizing with a known laminator such as a hydraulic press. While the temperature, the pressure and the time of heating and pressurizing depend on the laminator being used, they may be appropriately determined to achieve excellent lamination.

The obtained laminate includes a plurality of sensor elements 101. The laminate is cut into units of the sensor element 101. The cut laminate is fired at a predetermined firing temperature to obtain the sensor element 101. That is, the sensor element 101 is obtained by integral firing (co-firing) of the solid electrolyte layers and the electrodes. The firing temperature may be such a temperature that the solid electrolyte forming the base part 102 of the sensor element 101 is sintered to become a dense product, and an electrode or the like maintains desired porosity. The firing is conducted, for example, at a firing temperature of about 1200° C. or more and 1500° C. or less.

The obtained sensor element 101 is incorporated into the gas sensor 100 in such a form that the front end part of the sensor element 101 comes into contact with the measurement-object gas, and the rear end part of the sensor element 101 comes into contact with the reference gas.

As described above, according to the present invention, by using two kinds of proton conductors having different resistance values from each other, and providing with a current measurement pump cell and a voltage detection sensor cell, it is possible to provide a gas sensor that can measure a concentration of a hydrogen gas in a measurement-object gas in a wide concentration range with high accuracy.

### EXPLANATION OF REFERENCE SIGNS IN THE DRAWINGS

1: first substrate layer; 2: second substrate layer; 3: first spacer layer; 4, 204: first proton conductor layer; 214: lower proton conductor layer; 5: second spacer layer; 6: second proton conductor layer; 10: gas inlet; 11: diffusion-rate limiting path; 15: measurement-object gas flow cavity; 20: internal cavity; 21: current measurement pump cell; 22: inner measurement electrode; 23: outer electrode; 24: variable power supply (of the current measurement pump cell); 30:
reference gas chamber; 31: voltage detection sensor cell; 32: reference electrode; 70: heater part;
71: heater electrode; 72: heater; 73: through hole; 74: heater insulating layer; 76: heater lead; 90:
   control unit; 91: control part; 92: pump control part; 93: concentration calculating part; 100, 200:
   gas sensor; 101, 201: sensor element; and 102, 202: base part.

What is claimed is:

1. A gas sensor for detecting a hydrogen gas in a measurement-object gas, the gas sensor comprising a sensor element and a control unit for controlling the sensor element, wherein
the sensor element comprises:
a base part including a first solid electrolyte having proton conductivity, and a second solid electrolyte arranged at least partly in contact with the first solid electrolyte and having a lower resistance value of proton conduction than the first solid electrolyte;
a measurement-object gas flow cavity having a gas inlet that opens on a surface of the base part; and an internal cavity that communicates with the gas inlet via a diffusion-rate limiting path, on an inner surface of the internal cavity at least the second solid electrolyte being present;
a current measurement pump cell including: an intracavity measurement electrode disposed on the second solid electrolyte in the internal cavity of the measurement-object gas flow cavity; and an extracavity measurement electrode disposed at a position different from the measurement-object gas flow cavity on the base part, and adjacent to the intracavity measurement electrode via the second solid electrolyte;
a reference gas chamber formed inside the base part, and being separated from the measurement-object gas flow cavity, on an inner surface of the reference gas chamber at least the first solid electrolyte being present; and
a voltage detection sensor cell including: a reference electrode disposed on the first solid electrolyte in the reference gas chamber; and a detection electrode disposed at a position different from each of the reference gas chamber and the measurement-object gas flow cavity on the base part, and adjacent to the reference electrode via the first solid electrolyte or via the first solid electrolyte and the second solid electrolyte, and
the control unit comprises:
a pump control part for controlling the current measurement pump cell; and
a concentration calculating part for calculating a hydrogen concentration in a measurement-object gas, wherein
the concentration calculating part calculates the hydrogen concentration in the measurement-object gas based on an electromotive force generated in the voltage detection sensor cell; and/or calculates the hydrogen concentration in the measurement-object gas based on a current flowing through the current measurement pump cell.

2. The gas sensor according to claim 1, wherein
the concentration calculating part calculates the hydrogen concentration in the measurement-object gas based on the electromotive force generated in the voltage detection sensor cell when a value of the electromotive force generated in the voltage detection sensor cell is equal to or smaller than a predetermined threshold value; and
the concentration calculating part calculates the hydrogen concentration in the measurement-object gas based on the current flowing through the current measurement pump cell when the value of the electromotive force generated in the voltage detection sensor cell is larger than the predetermined threshold value.

3. The gas sensor according to claim 1, wherein
the concentration calculating part calculates the hydrogen concentration in the measurement-object gas based on the electromotive force generated in the voltage detection sensor cell when a value of the current flowing through the current measurement pump cell is equal to or smaller than a predetermined threshold value; and
the concentration calculating part calculates the hydrogen concentration in the measurement-object gas based on the current flowing through the current measurement pump cell when the value of the current flowing through the current measurement pump cell is larger than the predetermined threshold value.

4. The gas sensor according to claim 1, wherein
the concentration calculating part considers a hydrogen concentration calculated based on the electromotive force generated in the voltage detection sensor cell as the hydrogen concentration in the measurement-object gas when the hydrogen concentration calculated based on the electromotive force generated in the voltage detection sensor cell is equal to or smaller than a predetermined threshold value; and
the concentration calculating part calculates the hydrogen concentration in the measurement-object gas based on the current flowing through the current measurement pump cell when the hydrogen concentration calculated based on the electromotive force generated in the voltage detection sensor cell is larger than the predetermined threshold value.

5. The gas sensor according to claim 1, wherein
the concentration calculating part calculates the hydrogen concentration in the measurement-object gas based on the electromotive force generated in the voltage detection sensor cell when a hydrogen concentration calculated based on the current flowing through the current measurement pump cell is equal to or smaller than a predetermined threshold value; and
the concentration calculating part considers the hydrogen concentration calculated based on the current flowing through the current measurement pump cell as the hydrogen concentration in the measurement-object gas when the hydrogen concentration calculated based on the current flowing through the current measurement pump cell is larger than the predetermined threshold value.

6. The gas sensor according to claim 1, wherein the pump control part applies a predetermined voltage between the intracavity measurement electrode and the extracavity measurement electrode of the current measurement pump cell to make a current flow through the current measurement pump cell.

7. The gas sensor according to claim 1, wherein
the first solid electrolyte is a proton conductor selected from the group consisting of Ca—Zr—Mn—O based and Ca—Zr—In—O based perovskite compounds, and
the second solid electrolyte is a proton conductor selected from the group consisting of Sr—Zr—Y—O based, Ba—Zr—Y—O based, Ba—Ce—Y—O based and Sr—Zr—Yb—O based perovskite compounds.

8. A sensor element for detecting a hydrogen gas in a measurement-object gas, the sensor element comprising:
a base part including a first solid electrolyte having proton conductivity, and a second solid electrolyte arranged at least partly in contact with the first solid electrolyte and having a lower resistance value of proton conduction than the first solid electrolyte;
a measurement-object gas flow cavity having a gas inlet that opens on a surface of the base part; and an internal cavity that communicates with the gas inlet via a diffusion-rate limiting path, on an inner surface of the internal cavity at least the second solid electrolyte being present;
a current measurement pump cell including: an intracavity measurement electrode disposed on the second solid electrolyte in the internal cavity of the measurement-object gas flow cavity; and an extracavity measurement electrode disposed at a position different from the measurement-object gas flow cavity on the base part, and adjacent to the intracavity measurement electrode via the second solid electrolyte;
a reference gas chamber formed inside the base part, and being separated from the measurement-object gas flow cavity, on an inner surface of the reference gas chamber at least the first solid electrolyte being present; and
a voltage detection sensor cell including: a reference electrode disposed on the first solid electrolyte in the reference gas chamber; and a detection electrode disposed at a position different from each of the reference gas chamber and the measurement-object gas flow cavity on the base part, and adjacent to the reference electrode via the first solid electrolyte or via the first solid electrolyte and the second solid electrolyte.
